(19) United States
(12) Patent Application Publication
(10) Pub. No.: US 2022/0268587 A1
(43) Pub. Date: Aug. 25, 2022

(54) VEHICLE POSITION RECOGNITION APPARATUS

(71) Applicant: Honda Motor Co., Ltd., Tokyo (JP)

(72) Inventor: Yuichi Konishi, Wako-shi (JP)

(21) Appl. No.: 17/669,347

(22) Filed: Feb. 10, 2022

(30) Foreign Application Priority Data
Feb. 22, 2021 (JP) 2021-025878

(51) Int. Cl. G01C 21/30; G01C 21/00

(52) U.S. Cl. CPC G01C 21/30; G01C 21/3859

(57) ABSTRACT

A vehicle position recognition apparatus includes: a processor and a memory connected to the processor. The memory is configured to store: first map information of a first map of a first area; and second map information of a second map of a second area adjacent to the first area through an overlapped area between the first area and the second area. The processor is configured to perform: recognizing a first position of a vehicle in the overlapped area based on the first map information stored in the memory and recognizing a second position of the vehicle in the overlapped area based on the second map information stored in the memory; and calculating a deviation amount between the first map and the second map based on a difference between the first position and the second position recognized.

### CROSS-REFERENCE TO RELATED APPLICATION

This application is based upon and claims the benefit of priority from Japanese Patent Application No. 2021-025878 filed on Feb. 22, 2021, the content of which is incorporated herein by reference.

### BACKGROUND OF THE INVENTION

### Field of the Invention

This invention relates to a vehicle position recognition apparatus configured to recognize a position of a vehicle.

### Description of the Related Art

Conventionally, as this type of apparatus, an apparatus configured to estimate a self-position of an automated driving vehicle is known (for example, see Japanese Unexamined Patent Application Publication No. 2020-85886 (JP2020-085886A)). In an apparatus described in JP2020-085886A, a self-position on a map is estimated based on previously established map information including three-dimensional point cloud data acquired by LiDAR and GPS absolute coordinate data acquired by GPS.

Meanwhile, the vehicle may travel in boundary regions of a plurality of maps adjacent to each other. However, since there is a case where an inherent error is included in the map information of adjacent maps, when the self-position is estimated as in the apparatus described in JP2020-085886A, the estimation result of the self-position may vary, and in an apparatus that controls the traveling operation based on the map information, it may be difficult to perform smooth traveling control when traveling in a boundary region of a plurality of maps.

### SUMMARY OF THE INVENTION

An aspect of the present invention is a vehicle position recognition apparatus including: a processor and a memory connected to the processor. The memory is configured to store: first map information of a first map of a first area; and second map information of a second map of a second area adjacent to the first area through an overlapped area between the first area and the second area. The processor is configured to perform: recognizing a first position of a vehicle in the overlapped area based on the first map information stored in the memory and recognizing a second position of the vehicle in the overlapped area based on the second map information stored in the memory; and calculating a deviation amount between the first map and the second map based on a difference between the first position and the second position recognized.

### BRIEF DESCRIPTION OF THE DRAWINGS

The objects, features, and advantages of the present invention will become clearer from the following description of embodiments in relation to the attached drawings, in which:

FIG. 1 is a diagram illustrating an example of a travel scene of an automated driving vehicle to which a vehicle position recognition apparatus according to an embodiment of the present invention is applied;

FIG. 2 is a block diagram schematically illustrating an overall configuration of a vehicle control system of the automated driving vehicle to which the vehicle position recognition apparatus according to the embodiment of the present invention is applied;

FIG. 3 is a diagram illustrating an example of a traveling scene of the automated driving vehicle assumed by the vehicle position recognition apparatus according to the embodiment of the present invention;

FIG. 4 is a block diagram illustrating a main configuration of the vehicle position recognition apparatus according to the embodiment of the present invention; and

FIG. 5 is a flowchart illustrating an example of processing executed by a controller of FIG. 4.

### DETAILED DESCRIPTION OF THE INVENTION

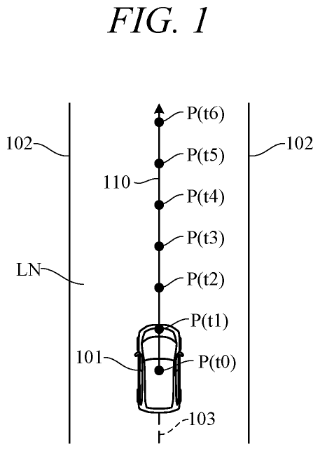

Hereinafter, an embodiment of the present invention will be described with reference to FIGS. 1 to 5. A vehicle position recognition apparatus according to the embodiment of the present invention can be applied to a vehicle having an automatic driving function (automated driving vehicle). The automated driving vehicle includes not only a vehicle that performs only traveling in an automatic driving mode in which a driving operation by a driver is unnecessary, but also a vehicle that performs traveling in an automatic driving mode and traveling in a manual driving mode by a driving operation by a driver.

FIG. 1 is a diagram illustrating an example of a travel scene of an automated driving vehicle (hereinafter, a vehicle) 101. FIG. 1 illustrates an example in which the vehicle 101 travels (lane-keep travel) while following a lane so as not to deviate from a lane LN defined by dividing lines 102. Note that the vehicle 101 may be any of an engine vehicle having an internal combustion engine as a traveling drive source, an electric vehicle having a traveling motor as a traveling drive source, and a hybrid vehicle having an engine and a traveling motor as traveling drive sources.

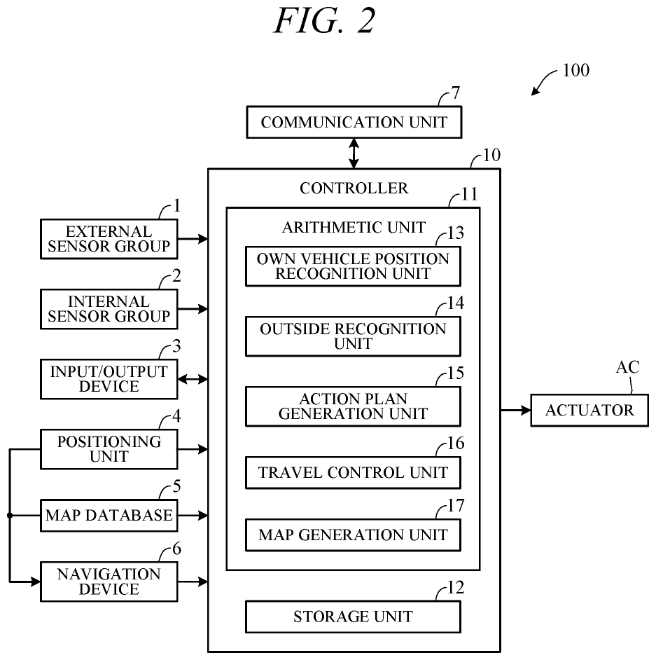

FIG. 2 is a block diagram schematically illustrating an overall configuration of a vehicle control system 100 of the vehicle 101 to which a vehicle position recognition apparatus according to the present embodiment is applied. As illustrated in FIG. 2, the vehicle control system 100 mainly includes a controller 10, an external sensor group 1, an internal sensor group 2, an input/output device 3, a positioning unit 4, a map database 5, a navigation device 6, a communication unit 7, and a traveling actuator AC each electrically connected to the controller 10.

The external sensor group 1 is a generic term for a plurality of sensors (external sensors) that detect an external situation which is peripheral information of the vehicle 101 (FIG. 1). For example, the external sensor group 1 includes a LiDAR that measures scattered light with respect to irradiation light in all directions of the vehicle 101 and measures a distance from the vehicle 101 to a surrounding obstacle, a radar that detects another vehicle, an obstacle, or the like around the vehicle 101 by irradiating electromagnetic waves and detecting a reflected wave, and a camera that is mounted on the vehicle 101 and has an imaging element such as a CCD or a CMOS to image the periphery of the vehicle 101 (forward, aft and lateral).

The internal sensor group 2 is a generic term for a plurality of sensors (internal sensors) that detect a traveling state of the vehicle 101. For example, the internal sensor group 2 includes a vehicle speed sensor that detects the vehicle speed of the vehicle 101, an acceleration sensor that detects the acceleration in the front-rear direction and the acceleration (lateral acceleration) in the left-right direction of the vehicle 101, a rotation speed sensor that detects the rotation speed of the traveling drive source, a yaw rate sensor that detects the rotation angular speed around the vertical axis of the center of gravity of the vehicle 101, and the like. The internal sensor group 2 further includes a sensor that detects driver's driving operation in a manual driving mode, for example, operation of an accelerator pedal, operation of a brake pedal, operation of a steering wheel, and the like.

The input/output device 3 is a generic term for devices to which a command is input from a driver or from which information is output to the driver. For example, the input/output device 3 includes various switches to which the driver inputs various commands by operating an operation member, a microphone to which the driver inputs a command by voice, a display that provides information to the driver with a display image, a speaker that provides information to the driver by voice, and the like.

The positioning unit (GNSS unit) 4 has a positioning sensor that receives a positioning signal transmitted from a positioning satellite. The positioning satellite is an artificial satellite such as a GPS satellite or a quasi-zenith satellite. The positioning unit 4 measures a current position (latitude, longitude, altitude) of the vehicle 101 by using the positioning information received by the positioning sensor.

The map database 5 is a device that stores general map information used in the navigation device 6, and is constituted of, for example, a hard disk or a semiconductor element. The map information includes road position information, information on a road shape (curvature or the like), and position information on intersections and branch points. The map information stored in the map database 5 is different from highly accurate map information stored in a storage unit 12 of the controller 10.

The navigation device 6 is a device that searches for a target route on a road to a destination input by a driver and provides guidance along the target route. The input of the destination and the guidance along the target route are performed via the input/output device 3. The target route is calculated based on a current position of the vehicle 101 measured by the positioning unit 4 and the map information stored in the map database 5. The current position of the vehicle 101 can be measured using the detection values of the external sensor group 1, and the target route may be calculated based on the current position and the highly accurate map information stored in the storage unit 12.

The communication unit 7 communicates with various servers (not illustrated) via a network including a wireless communication network represented by the Internet network, a mobile phone network, or the like, and acquires map information, travel history information, traffic information, and the like from the servers periodically or at an arbitrary timing. The travel history information of the vehicle 101 may be transmitted to the server via the communication unit 7 in addition to the acquisition of the travel history information. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the storage unit 12, and the map information is updated.

The actuator AC is a traveling actuator for controlling traveling of the vehicle 101. When the traveling drive source is an engine, the actuator AC includes a throttle actuator that adjusts an opening degree of a throttle valve of the engine and an injector actuator that adjusts a valve opening timing and a valve opening time of the injector. When the traveling drive source is a traveling motor, the traveling motor is included in the actuator AC. The actuator AC also includes a brake actuator that operates the braking device of the vehicle 101 and a steering actuator that drives the steering device.

The controller 10 includes an electronic control unit (ECU). More specifically, the controller 10 includes a computer including an arithmetic unit 11 such as a CPU (microprocessor), the storage unit 12 such as a ROM and a RAM, and other peripheral circuits (not illustrated) such as an I/O interface. Although a plurality of ECUs having different functions such as an engine control ECU, a traveling motor control ECU, and a braking device ECU can be separately provided, the controller 10 is illustrated, in FIG. 2, as a set of these ECUs for convenience.

The storage unit 12 stores highly accurate detailed road map information for traveling. The road map information includes road position information, information of a road shape (curvature or the like), information of a road gradient, position information of an intersection or a branch point, information of type and position of dividing lines such as white lines, information of the number of lanes, width of a lane and position information for each lane (information of a center position of a lane or a boundary line of a lane position), position information of a landmark (traffic lights, signs, buildings, etc.) as a mark on a map, and information of a road surface profile such as unevenness of a road surface.

The map information stored in the storage unit 12 includes map information (referred to as external map information) acquired from the outside of the vehicle 101 via the communication unit 7 and map information (referred to as internal map information) created by the vehicle 101 itself using detection values of the external sensor group 1 or detection values of the external sensor group 1 and the internal sensor group 2.

The external map information is, for example, information of a general-purpose map (referred to as a cloud map) generated based on data collected by a dedicated surveying vehicle or a general automated driving vehicle traveling on a road and distributed to the general automated driving vehicle via a cloud server. The external map is generated for an area with a large traffic volume such as a highway or an urban area, but is not generated for an area with a small traffic volume such as a residential area or a suburb.

On the other hand, the internal map information is information of a map (referred to as an environment map) including point cloud data generated by mapping using a technology such as simultaneous localization and mapping (SLAM) based on data collected by each automated driving vehicle traveling on a road. The external map information is shared by the vehicle 101 and other automated driving vehicles, whereas the internal map information is dedicated map information (for example, map information that the vehicle 101 independently has) generated by the vehicle 101 and used for automated driving of the vehicle 101. In a region where external map information is not provided, such as a newly constructed road, an environment map is created by the vehicle 101 itself. Note that the internal map information may be provided to a server device or another automated driving vehicle via the communication unit 7.

The storage unit 12 also stores information such as various control programs and a threshold used in the programs.

The arithmetic unit 11 includes an own vehicle position recognition unit 13, an outside recognition unit 14, an action plan generation unit 15, a travel control unit 16, and a map generation unit 17 as functional configurations. In other words, the arithmetic unit 11 such as a CPU (microprocessor) of the controller 10 functions as the own vehicle position recognition unit 13, outside recognition unit 14, action plan generation unit 15, travel control unit 16, and map generation unit 17.

The own vehicle position recognition unit 13 highly accurately recognizes the position of the vehicle 101 on the map (own vehicle position) based on the highly accurate detailed road map information (external map information, internal map information) stored in the storage unit 12 and the peripheral information of the vehicle 101 detected by the external sensor group 1. When the own vehicle position can be measured by a sensor installed on the road or outside a road side, the own vehicle position can be recognized by communicating with the sensor via the communication unit 7. The own vehicle position may be recognized using the position information of the vehicle 101 obtained by the positioning unit 4. The movement information (moving direction, moving distance) of the own vehicle may be calculated based on the detection values of the internal sensor group 2, and the own vehicle position may be recognized accordingly.

The outside recognition unit 14 recognizes an external situation around the vehicle 101 based on the signal from the external sensor group 1 such as a LiDAR, a radar, and a camera. For example, the position, speed, and acceleration of a surrounding vehicle (a front vehicle or a rear vehicle) traveling around the vehicle 101, the position of a surrounding vehicle stopped or parked around the vehicle 101, and the positions and states of other objects are recognized. Other objects include signs, traffic lights, signs such as dividing lines (white lines, etc.) or stop lines on roads, buildings, guardrails, utility poles, signboards, pedestrians, bicycles, and the like. The states of other objects include a color of a traffic light (red, green, yellow), the moving speed and direction of a pedestrian or a bicycle, and the like. A part of the stationary object among the other objects constitutes a landmark serving as an index of the position on the map, and the outside recognition unit 14 also recognizes the position and type of the landmark.

The action plan generation unit 15 generates a traveling path (target path) of the vehicle 101 from a current point of time to a predetermined time ahead based on, for example, the target route calculated by the navigation device 6, the map information stored in the storage unit 12, the own vehicle position recognized by the own vehicle position recognition unit 13, and the external situation recognized by the outside recognition unit 14. More specifically, the target path of the vehicle 101 is generated on the external map or the internal map based on the external map information or the internal map information stored in the storage unit 12. When there are a plurality of paths that are candidates for the target path on the target route, the action plan generation unit 15 selects, from the plurality of paths, an optimal path that satisfies criteria such as compliance with laws and regulations and efficient and safe traveling, and sets the selected path as the target path. Then, the action plan generation unit 15 generates an action plan corresponding to the generated target path.

The action plan includes travel plan set for each unit time (for example, 0.1 seconds) from a current point of time to a predetermined time (for example, 5 seconds) ahead, that is, travel plan set in association with a time for each unit time. The travel plan includes information on an own vehicle position of the vehicle 101 and information on a vehicle state per unit time. The own vehicle position information is, for example, two-dimensional coordinate position information on a road, and the vehicle state information is vehicle speed information indicating a vehicle speed, direction information indicating a direction of the vehicle 101, and the like. Therefore, when the vehicle is supposed to accelerate to a target vehicle speed within a predetermined time, the information of the target vehicle speed is included in the action plan. The vehicle state can be obtained from a change in the own vehicle position per unit time. The travel plan is updated every unit time.

FIG. 1 illustrates an example of the action plan generated by the action plan generation unit 15, that is, a travel plan of a scene in which the vehicle 101 travels in the lane-keep travel so as not to deviate from the lane LN. Each point P in FIG. 1 corresponds to the own vehicle position for each unit time from the current time (time t0) to a predetermined time ahead, and the target path 110 is obtained by connecting these points P in time order. The target path 110 is generated, for example, along the center line 103 of the pair of dividing lines 102 defining the lane LN. The target path 110 may be generated along a past travel path included in the map information. Note that the action plan generation unit 15 generates various action plans corresponding to overtaking travel in which the vehicle 101 moves to another lane and overtakes the preceding vehicle, lane change travel in which the vehicle moves to another lane, deceleration travel, acceleration travel, or the like, in addition to the lane-keep travel. When generating the target path 110, the action plan generation unit 15 first determines a travel mode and generates the target path 110 based on the travel mode. The information on the target path 110 generated by the action plan generation unit 15 is added to the map information and stored in the storage unit 12, and is taken into consideration when the action plan generation unit 15 generates an action plan at the time of the next travel.

In the automated driving mode, the travel control unit 16 controls each of the actuators AC so that the vehicle 101 travels along the target path 110 generated by the action plan generation unit 15. More specifically, the travel control unit 16 calculates a requested driving force for obtaining the target acceleration for each unit time calculated by the action plan generation unit 15 in consideration of travel resistance determined by a road gradient or the like in the automated driving mode. Then, for example, the actuator AC is feedback controlled so that an actual acceleration detected by the internal sensor group 2 becomes the target acceleration. That is, the actuator AC is controlled so that the vehicle 101 travels at the target vehicle speed and the target acceleration. In the manual driving mode, the travel control unit 16 controls each actuator AC in accordance with a travel command (steering operation or the like) from the driver acquired by the internal sensor group 2.

The map generation unit 17 generates the environment map constituted by three-dimensional point cloud data using detection values detected by the external sensor group 1 during traveling in the manual driving mode. Specifically, an edge indicating an outline of an object is extracted from a camera image acquired by the camera based on luminance and color information for each pixel, and a feature point is extracted using the edge information. The feature point is, for example, an intersection of the edges, and corresponds to a corner of a building, a corner of a road sign, or the like. The map generation unit 17 calculates the distance to the extracted feature point and sequentially plots the feature point on the environment map, thereby generating the environment map around the road on which the subject vehicle has traveled. The environment map may be generated by extracting the feature point of an object around the subject vehicle using data acquired by radar or LiDAR instead of the camera.

The own vehicle position recognition unit 13 performs own vehicle position estimation processing in parallel with map generation processing by the map generation unit 17. That is, the position of the subject vehicle is estimated based on a change in the position of the feature point over time. The map creation processing and the position estimation processing are simultaneously performed, for example, according to an algorithm of SLAM. The map generation unit 17 can generate the environment map not only when the vehicle travels in the manual driving mode but also when the vehicle travels in the automated driving mode. If the environment map has already been generated and stored in the storage unit 12, the map generation unit 17 may update the environment map with a newly obtained feature point.

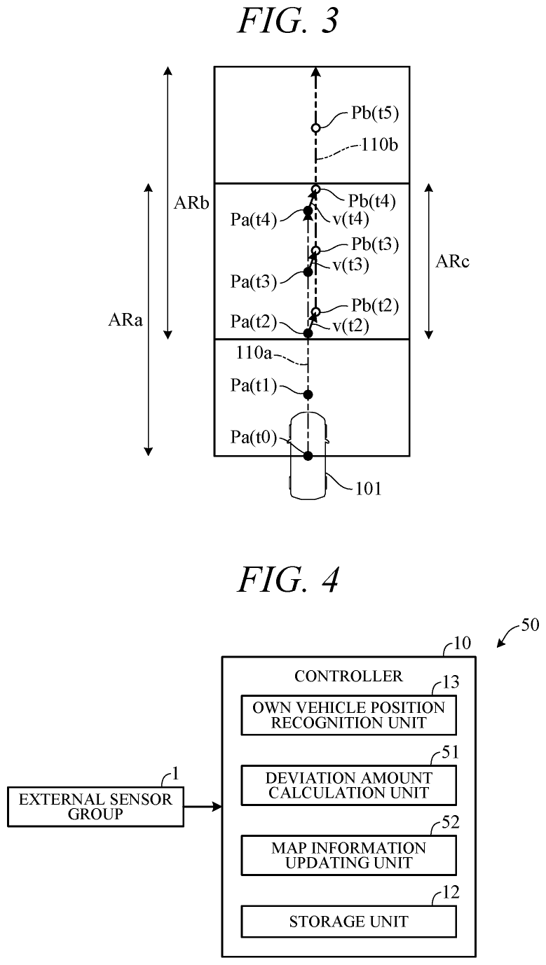

A configuration of the vehicle position recognition apparatus according to the present embodiment will be described. FIG. 3 is a diagram illustrating an example of a traveling scene of the vehicle 101 assumed by the vehicle position recognition apparatus according to the present embodiment, and illustrates a scene in which the vehicle 101 travels in the lane-keep travel so as not to deviate from the lane LN as in FIG. 1. Hereinafter, an area that an internal map such as an environment map is stored in the storage unit 12 is referred to as an internal map area ARa, and an area that an external map such as a cloud map is stored in the storage unit 12 is referred to as an external map area ARb.

Each piece of map information includes an inherent error due to a distance measurement error when the map is generated. Therefore, as illustrated in FIG. 3, the own vehicle position Pa recognized based on the internal map information by the own vehicle position recognition unit 13 may not coincide with the own vehicle position Pb recognized based on the external map information. For example, the recognition results of the own vehicle positions Pa(t2) and Pb(t2) vary at the timing when the map information used for the recognition of the own vehicle position by the own vehicle position recognition unit 13 is switched (For example, time t2).

In this manner, it may be difficult to perform smooth travel control of the vehicle 101 when the vehicle travels in the automated driving mode in the boundary region between the internal map area ARa and the external map area ARb in a state where the recognition result of the own vehicle position varies. For example, as illustrated in FIG. 3, when the recognition result of the own vehicle position varies in the traveling direction of the vehicle 101, the own vehicle position is switched from a point Pa(t2) behind in the traveling direction to a point Pb(t2) ahead in the traveling direction, so that it is erroneously recognized that the vehicle 101 has traveled too much with respect to the travel plan. In this case, the vehicle 101 may perform sudden decelerating or sudden braking, which causes discomfort to the occupant of the vehicle 101 and the surrounding vehicle.

Similarly, when the variation in the recognition result of the own vehicle position occurs in the opposite direction of the traveling direction of the vehicle 101, the vehicle 101 is erroneously recognized as being delayed with respect to the travel plan, and the vehicle 101 may be suddenly accelerated. In addition, when the variation in the recognition result of the own vehicle position occurs in the vehicle width direction of the vehicle 101, the vehicle 101 may be erroneously recognized as deviating from the target path 110, and the vehicle 101 may make a sudden turn.

Therefore, in the present embodiment, the vehicle position recognition apparatus is configured as follows so that it is possible to smoothly perform travel control when traveling in the boundary region of the plurality of maps by grasping an error inherent to the plurality of maps as the deviation amount and eliminating the variation in the recognition result of the own vehicle position based on the deviation amount.

FIG. 4 is a block diagram illustrating a main configuration of the vehicle position recognition apparatus 50 according to the embodiment of the present invention. The vehicle position recognition apparatus 50 constitutes a part of the vehicle control system 100 in FIG. 2. As illustrated in FIG. 4, the vehicle position recognition apparatus 50 includes the controller 10 and the external sensor group 1. The controller 10 of FIG. 4 includes a deviation amount calculation unit 51 and a map information updating unit 52 in addition to the own vehicle position recognition unit 13 as a functional configuration which the arithmetic unit 11 (FIG. 2) is responsible for. That is, the arithmetic unit 11 such as a CPU (microprocessor) of the controller 10 functions as the deviation amount calculation unit 51 and the map information updating unit 52 in addition to the own vehicle position recognition unit 13. In the storage unit 12 of FIG. 4, the internal map information of the internal map area ARa and the external map information of the external map area ARb are stored in advance.

The deviation amount calculation unit 51 calculates the deviation amount v between the internal map and the external map based on the difference between the own vehicle positions Pa and Pb recognized by the own vehicle position recognition unit 13 in the overlapping area ARc between the internal map area ARa and the external map area ARb. More specifically, as illustrated in FIG. 3, based on the own vehicle positions Pa(tn), Pb(tn) recognized at the same time tn (in the example of FIG. 3, tn=t2, t3, and t4), the deviation amount v(tn) is calculated as a vector having the point Pa(tn) as a start point and the point Pb(tn) as an end point.

The deviation amount calculation unit 51 calculates the deviation amount v between the internal map and the external map, for example, as an arithmetic mean of a plurality of displacement amounts v(tn). In this case, in order to ensure the reliability of the deviation amount v, the deviation amount v may be calculated only when the number of pairs of the own vehicle positions Pa(tn) and Pb(tn) recognized in the overlapping area ARc is equal to or larger than a predetermined number. Alternatively, the outlier may be excluded from the recognition result of the own vehicle position by a random sample consensus (RANSAC) method or the like.

Since the deviation amount calculation unit 51 calculates the deviation amount v based on the recognition result by a single algorithm of the own vehicle position recognition unit 13, it is possible to calculate the deviation amounts of a plurality of maps regardless of the data format of the original map information. Note that the own vehicle position recognized by the own vehicle position recognition unit 13 may be a two-dimensional coordinate position or a three-dimensional coordinate position. Based on the plurality of deviation amounts v(tn), it is possible to grasp the deviation of the postures of the plurality of maps, that is, the deviation of the postures when the plurality of maps is arranged in the common coordinate space.

The map information updating unit 52 adds information on the deviation amount v between the internal map and the external map calculated by the deviation amount calculation unit 51 to the internal map information, and updates the internal map information stored in the storage unit 12. In other words, information on the deviation amount v of the internal map on the vehicle 101 side with respect to the external map, which is a general-purpose map used by many automated driving vehicles including the vehicle 101, is added to the internal map information, and the internal map information stored in the storage unit 12 is updated.

The information on the deviation amount v of the internal map with respect to the external map stored in the storage unit 12 is taken into consideration in the subsequent travel control in the automated driving mode. For example, based on the deviation amount v, the target path 110 is generated by the action plan generation unit 15 so that the target path 110a (FIG. 3) generated on the internal map and the target path 110b (FIG. 3) generated on the external map are smoothly connected in the boundary region. Note that the map information updating unit 52 may entirely correct (offset) the position information of the internal map information in accordance with the external map information based on the deviation amount v and update the internal map information stored in the storage unit 12.

The updated internal map information stored in the storage unit 12 may be transmitted to another automated driving vehicle by inter-vehicle communication, or may be transmitted to a map information management server or the like provided outside the vehicle 101. In this case, it is possible to share the internal map information generated on the vehicle 101 side in an effective manner by sharing the information of the deviation amount v calculated based on the external map common to each automated driving vehicle.

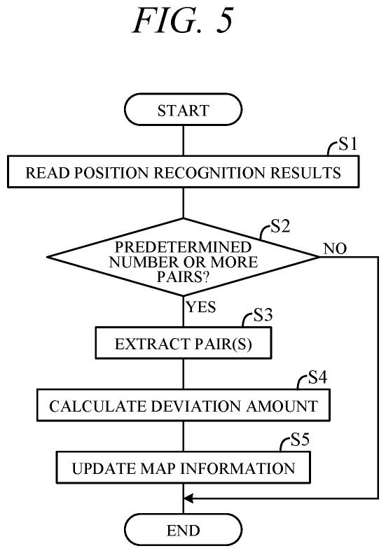

FIG. 5 is a flowchart illustrating an example of processing executed by the controller 10 of FIG. 4. The processing illustrated in this flowchart is started, for example, after the vehicle 101 travels in the overlapping area ARc between the internal map area ARa and the external map area ARb in the manual driving mode. First, in S1 (S: processing step), recognition results of the own vehicle positions Pa(tn) and Pb(tn) in the overlapping area ARc are read. Next, in S2, it is determined whether the number of pairs of the own vehicle positions Pa(tn) and Pb(tn) read in S1 is equal to or larger than a predetermined number. When the determination result is positive in S2, the process proceeds to S3, and when the determination result is negative, the process ends.

In S3, outliers are excluded from the recognition results of the own vehicle positions Pa(tn) and Pb(tn), and pair(s) of appropriate own vehicle positions Pa(tn) and Pb(tn) is extracted. Next, in S4, a deviation amount v between the internal map and the external map is calculated. Next, in S5, information on the deviation amount v between the internal map and the external map calculated in S4 is added to the internal map information, the internal map information stored in the storage unit 12 is updated, and the processing is terminated.

As described above, by calculating the deviation amount v based on the recognition result of the position of the own vehicle when the own vehicle travels in the overlapping area ARc in the manual driving mode, smooth traveling control can be performed when the own vehicle travels in the boundary region between the internal map area ARa and the external map area ARb in the automated driving mode. In other words, by grasping in advance the deviation amounts v of the plurality of maps used for travel control in the automated driving mode, it is possible to eliminate variations in the recognition results of the own vehicle positions Pa and Pb based on the deviation amounts v and to perform smooth travel control when traveling in the boundary regions of the plurality of maps.

For example, based on the deviation amount v, the traveling operation can be controlled so that the target path 110a (FIG. 3) generated on the internal map and the target path 110b (FIG. 3) generated on the external map are smoothly connected in the boundary region. The variation in the recognition result of the own vehicle position may be eliminated by entirely correcting the position information of the internal map information in accordance with the external map information based on the deviation amount v.

The present embodiment can achieve advantages and effects such as the following:

(1) The vehicle position recognition apparatus 50 includes: the storage unit 12 configured to store: the internal map information of the internal map area ARa; and the external map information of the external map area ARb adjacent to the internal map area ARa through the overlapped area ARc between the internal map area ARa and the external map area ARb; the vehicle position recognition unit 13 configured to recognize the vehicle position Pa of the vehicle 101 in the overlapped area ARc based on the internal map information stored in the storage unit 12 and configured to recognize the vehicle position Pb of the vehicle 101 in the overlapped area ARc based on the external map information stored in the storage unit 12; and the deviation amount calculation unit 51 configured to calculate the deviation amount v between the internal map and the external map based on a difference between the vehicle positions Pa, Pb recognized by the vehicle position recognition unit 13 (FIG. 4).

As a result, since the deviation amounts v of the plurality of maps can be grasped, for example, by eliminating variations in the recognition results of the own vehicle positions Pa and Pb based on the deviation amounts v, smooth traveling control can be performed when traveling in the boundary regions of the plurality of maps. In addition, since the deviation amount v is calculated based on the recognition result by the single own vehicle position recognition algorithm for each automated driving vehicle, the deviation amount v of a plurality of maps can be calculated regardless of the data format of the original map information.

(2) The deviation amount calculation unit 51 calculates the deviation amount v between the internal map and the external map based on the difference between the vehicle positions Pa(tn), Pb(tn) recognized by the vehicle position recognition unit 13 at the same time point tn. In other words, it is possible to accurately calculate the deviation amounts v of the plurality of maps based on the own vehicle positions Pa(tn) and Pb(tn) recognized at the same time tn.

(3) The deviation amount calculation unit 51 calculates the deviation amount v between the internal map and the external map based on the difference between each pair of the vehicle positions Pa, Pb of a plural pairs of the vehicle positions Pa, Pb recognized by the vehicle position recognition unit 13. In this case, it is possible to grasp a deviation in posture when a plurality of maps is arranged in a common coordinate space.

The above embodiment may be modified into various forms. Hereinafter, some modifications will be described. According to the above embodiment, the example of calculating the deviation amount v between the internal map such as the environment map and the external map such as the cloud map has been described, but the first map and the second map are not limited to such a configuration. For example, the deviation amount between the internal map and the external map acquired from another automated driving vehicle by inter-vehicle communication may be calculated, or the deviation amounts of a plurality of external maps may be calculated.

According to the above embodiment, the example in which the vehicle position recognition apparatus 50 constitutes a part of the vehicle control system 100 has been described, but the vehicle position recognition apparatus is not limited to such an example. For example, it may constitute a part of a map information management server or the like provided outside the vehicle 101. In this case, for example, a recognition result (travel history information) of the position of the own vehicle is acquired from each vehicle, and deviation amounts of a plurality of maps are calculated on the server side.

According to the above embodiment, an example in which a plurality of maps are displaced in the traveling direction or the vehicle width direction of the vehicle 101 has been described with reference to FIG. 3 and the like, but the deviation amount can also be calculated by a similar method for the deviation generated in the height direction of the vehicle 101.

The above embodiment can be combined as desired with one or more of the above modifications. The modifications can also be combined with one another.

According to the present invention, since the deviation amounts of the plurality of maps can be grasped, it is possible to smoothly perform travel control when traveling in the boundary regions of the plurality of maps by eliminating variations in the recognition results of the vehicle positions based on the deviation amounts.

Above, while the present invention has been described with reference to the preferred embodiments thereof, it will be understood, by those skilled in the art, that various changes and modifications may be made thereto without departing from the scope of the appended claims.

What is claimed is:

1. A vehicle position recognition apparatus, comprising:
a processor and a memory connected to the processor, wherein
the memory is configured to store: first map information of a first map of a first area; and second map information of a second map of a second area adjacent to the first area through an overlapped area between the first area and the second area, wherein
the processor is configured to perform:
recognizing a first position of a vehicle in the overlapped area based on the first map information stored in the memory and recognizing a second position of the vehicle in the overlapped area based on the second map information stored in the memory; and
calculating a deviation amount between the first map and the second map based on a difference between the first position and the second position recognized.

2. The vehicle position recognition apparatus according to claim 1, wherein
the processor is configured to perform:
calculating the deviation amount between the first map and the second map based on the difference between the first position and the second position recognized at the same time point.

3. The vehicle position recognition apparatus according to claim 2, wherein
the processor is configured to perform:
calculating the deviation amount between the first map and the second map as a vector starting from the first position and ending at the second position recognized at the same time point.

4. The vehicle position recognition apparatus according to claim 1, wherein
the processor is configured to perform:
calculating the deviation amount between the first map and the second map based on the difference between each pair of the first position and the second position of a plural pairs of the first position and the second position.

5. The vehicle position recognition apparatus according to claim 4, wherein
the processor is configured to perform:
calculating the deviation amount between the first map and the second map on a condition that a number of the pair of the first position and the second position is equal to or greater than a predetermined number.

6. The vehicle position recognition apparatus according to claim 1, wherein
the memory is further configured to store: one single algorithm for recognizing position of the vehicle based on map information, wherein
the processor is configured to perform:
recognizing the first position based on the first map information and recognizing the second position based on the second map information using the one single algorithm stored in the memory.

7. The vehicle position recognition apparatus according to claim 1, wherein
the processor is further configured to perform:
updating the first map information stored in the memory based on the deviation amount between the first map and the second map calculated.

8. The vehicle position recognition apparatus according to claim 1, wherein
the processor is configured to perform:
calculating the deviation amount between the first map and the second map after the vehicle has traveled the overlapped area.

9. A vehicle position recognition apparatus, comprising:
a processor and a memory connected to the processor, wherein
the memory is configured to store: first map information of a first map of a first area; and second map information of a second map of a second area adjacent to the first area through an overlapped area between the first area and the second area, wherein
the processor is configured to function as:
a position recognition unit configured to recognize a first position of a vehicle in the overlapped area based on the first map information stored in the memory and configured to recognize a second position of the vehicle in the overlapped area based on the second map information stored in the memory; and
a deviation amount calculation unit configured to calculate a deviation amount between the first map and the second map based on a difference between the first position and the second position recognized by the position recognition unit.

10. The vehicle position recognition apparatus according to claim 9, wherein
the deviation amount calculation unit calculates the deviation amount between the first map and the second map based on the difference between the first position and the second position recognized by the position recognition unit at the same time point.

11. The vehicle position recognition apparatus according to claim 10, wherein
the deviation amount calculation unit calculates the deviation amount between the first map and the second map as a vector starting from the first position and ending at the second position recognized by the position recognition unit at the same time point.

12. The vehicle position recognition apparatus according to claim 9, wherein
the deviation amount calculation unit calculates the deviation amount between the first map and the second map based on the difference between each pair of the first position and the second position of a plural pairs of the first position and the second position.

13. The vehicle position recognition apparatus according to claim 12, wherein
the deviation amount calculation unit calculates the deviation amount between the first map and the second map on a condition that a number of the pair of the first position and the second position is equal to or greater than a predetermined number.

14. The vehicle position recognition apparatus according to claim 9, wherein
the memory is further configured to store: one single algorithm for recognizing position of the vehicle based on map information, wherein
the position recognition unit recognizes the first position based on the first map information and recognizes the second position based on the second map information using the one single algorithm stored in the memory.

15. The vehicle position recognition apparatus according to claim 9, wherein
the processor is further configured to function as:
a map information updating unit configured to update the first map information stored in the memory based on the deviation amount between the first map and the second map calculated by the deviation amount calculation unit.

16. The vehicle position recognition apparatus according to claim 9, wherein
the deviation amount calculation unit calculates the deviation amount between the first map and the second map after the vehicle has traveled the overlapped area.
